(19) United States
(12) Patent Application Publication
(10) Pub. No.: US 2026/0152230 A1
(43) Pub. Date: Jun. 4, 2026

(54) A STEER-BY-WIRE STEERING ASSEMBLY

(71) Applicant: CHASSIS AUTONOMY SBA AB, Trollhättan (SE)

(72) Inventor: Thomas LI, London (GB)

(73) Assignee: CHASSIS AUTONOMY SBA AB, Trollhättan (SE)

(21) Appl. No.: 19/120,925

(22) PCT Filed: Oct. 24, 2023
(86) PCT No.: PCT/SE2023/051047

§ 371 Date: Apr. 14, 2025

(30) Foreign Application Priority Data
Nov. 4, 2022 (SE) 2230353-1

(51) Int. Cl. B62D 15/02

(52) U.S. Cl. CPC B62D 15/0245; B62D 15/0225; B62D 15/024

(57) ABSTRACT

A steer-by-wire steering assembly comprises a motor assembly having at least one rotor and at least one stator and an electronic control unit. The steering assembly comprises an actuator operatively coupled to the at least one rotor and a steering shaft connectable to a first tie rod and a second tie rod. The steering shaft is configured to engage with the actuator and to move longitudinally with respect to the housing when the motor assembly is actuated. A steering shaft displacement sensor is configured to send a signal to the electronic control unit in dependence of detecting a centre reference target of the steering shaft. Wherein the electronic control unit is configured to determine a vehicle steady state condition and determine in dependence of the received signal from the steering shaft displacement sensor a steering shaft offset when the vehicle is in the vehicle steady state condition.

### BACKGROUND

### Field

The present disclosure relates to a steer-by-wire steering assembly.

### Description of Related Art

One aspect of autonomous vehicular control that is needed is autonomous steering. Typically, the steering systems required in autonomous vehicles are steer-by-wire steering systems which can be controlled by control signals from a vehicle control unit.

In the absence of a user input, the vehicular systems of the autonomous vehicle need to be robust in order for an autonomous vehicle to be reliable. This may mean that the steer-by-wire systems have multiple redundancies in order to meet industrial safety standards e.g., Automotive Safety Integrity Level (ASIL) C or D ISO 26262.

In order for a steer-by-wire system to be reliable enough for an autonomous vehicle and associated legal requirements, the steer-by-wire system may need to be fail-operational. This means that if the steer-by-wire system incurs a fault, the autonomous vehicle can still function, even if it is at a reduced operational capacity.

In some circumstances, the steering system in a vehicle can be affected by faults with other vehicle components such as the wheels. For example, in US2022017142 shows a vehicle steering system which detects if the vehicle has a lateral drift. The vehicle steering system issues a compensation steering command based on the deviation of the steering position. A problem with this is that the lateral drift may be due to an underlying problem and only compensating for the lateral drift can be a safety issue if the vehicle continues to experience the lateral drift, where the root cause may lead to further degradation if undetected and impact upon safe vehicle operation.

JP2022062982 detects an abnormality in a tire pressure determined from abnormal steering torque and steering angle parameters for a steering system with a manual steering wheel. This means that the steering torque and steering angle are determined in dependence of manual input from the user. Such a system is often unnecessary because the user can feel the lateral drift on the steering wheel due to low tyre pressure. Furthermore, this system is not suitable for a steering system without a manually operated steering wheel.

### SUMMARY

Examples of the present disclosure aim to address the aforementioned problems.

In a first aspect of the disclosure there is provided a steer-by-wire steering assembly for a vehicle comprising: a housing; at least one electronic control unit; a motor assembly having at least one rotor and at least one stator and the at least one electronic control unit is configured to control the motor assembly; an actuator operatively coupled to the at least one rotor; a steering shaft connectable to a first tie rod and a second tie rod, the steering shaft configured to engage with the actuator and to move longitudinally with respect to the housing when the motor assembly is actuated; a steering shaft displacement sensor configured to send a signal to the at least one electronic control unit in dependence of detecting a reference target of the steering shaft; wherein the electronic control unit is configured to determine a vehicle steady state condition and determine in dependence of the received signal from the steering shaft displacement sensor a steering shaft offset when the vehicle is in the vehicle steady state condition.

This means that the steer-by-wire steering assembly can determine one or more faults with the wheels or other components of the vehicle with a displacement sensor detecting the relative position of the steering shaft. For example, a steering shaft displacement sensor can detect the delta between the actual steering shaft position when the vehicle is moving straight ahead and the geometric centre position of the steering shaft to detect low tire pressure. This means that this can provide additional sensor redundancy for determining the tire pressure. In the event that a tire pressure sensor fails, the vehicle can still determine if there is a fault condition with a wheel. This allows the steer-by-wire steering assembly to provide additional fail operational redundancy to other parts, sub-systems and systems of the vehicle.

By relying on the displacement sensor information of the steering shaft, the absolute position of the steering shaft is used to reliably determine a fault condition in a wheel e.g., low pressure in a tire. This means the displacement sensor information can be used in a fail operational system for the tire pressure sensor system. This means that steer-by-wire steering assembly can determine the fault condition without relying on other intermediary systems.

Optionally, the reference target indicates a midpoint of the steering shaft and when the centre reference target is detected by the steering shaft displacement sensor, the midpoint of the steering shaft is aligned with a geometric centre of the steering assembly.

Optionally, the at least one electronic control unit is configured to determine a displacement of the steering shaft in dependence of the received signal from the steering shaft displacement sensor and rotational information of the at least one rotor.

Optionally, the at least one electronic control unit is configured to receive an indication of a vehicle steady state or information for determining a vehicle steady state condition.

Optionally, the at least one electronic control unit is configured to receive the indication of a vehicle steady state or information for determining a vehicle steady state condition from a vehicle control unit, a vehicle movement controller, a controller area network of the vehicle, a yaw rate sensor, at least one wheel speed sensor, or at least one ride height sensor.

Optionally, the indication of the vehicle steady state comprises a yaw rate of the vehicle, and/or wheel speed.

Optionally, the at least one electronic control unit determines that the vehicle has a vehicle steady state condition when the yaw rate is or approximately 0 radians per second.

Optionally, the at least one electronic control unit is configured to determine a steering fault condition based the determination that steering shaft is offset when the vehicle is in a vehicle steady state.

Optionally, the at least one electronic control unit is configured to determine the steering fault condition when the offset of the steering shaft exceeds a predetermined displacement.

Optionally, the at least one electronic control unit is configured to determine the steering fault condition when a period of time that steering shaft is offset exceeds a predetermined time period.

Optionally, the at least one electronic control unit is configured to determine the steering fault condition when the relationship between the offset and a yaw rate of the vehicle exceeds a predetermined permitted variation.

Optionally, the at least one electronic control unit is configured to determine that the offset varies in dependence of the wheel rotation and/or with wheel speed.

Optionally, the at least one electronic control unit is configured to determine whether the steering fault condition is one or more of a tire pressure fault, chassis geometry fault, or out of balance wheel, or wheel bearing fault.

Optionally, the at least one electronic control unit is configured to receive a signal from a tire pressure sensor.

Optionally, the at least one electronic control unit is configured to determine a flat tire condition based on the signal received from the tire pressure sensor, and the steering fault condition.

Optionally, the actuator is a screw actuator configured to engage a threaded portion on the steering shaft.

Optionally, the motor assembly comprises a first motor having a first stator comprising a first motor winding and a second motor having a second stator comprising a second motor winding wherein the at least one rotor is common to both the first motor and the second motor.

Optionally, the at least one electronic control unit is a first electronic control unit configured to control the first motor winding and a second electronic control unit configured to control the second motor winding.

Optionally, the at least one electronic control unit is configured to receive a sensor signal from a tire pressure sensor or a tire pressure loss sensor.

Optionally, the at least one electronic control unit is configured to determine a fault condition of tire pressure sensor on the basis of the determined vehicle steady state condition and the received signal from the steering shaft displacement sensor.

In a second aspect of the disclosure there is provided a method of controlling a steer-by-wire steering assembly for a vehicle having a housing; at least one electronic control unit; a motor assembly having at least one rotor and at least one stator and the at least one electronic control unit is configured to control the motor assembly, an actuator operatively coupled to the at least one rotor; and a steering shaft connectable to a first tie rod and a second tie rod, the steering shaft configured to engage with the actuator and to move longitudinally with respect to the housing when the motor assembly is actuated, the method comprising: detecting a reference target of the steering shaft with a steering shaft displacement sensor; sending a signal from the steering shaft displacement sensor to the at least one electronic control unit; determining a vehicle steady state condition; determining in dependence of the received signal from the steering shaft displacement sensor that a displacement of the steering shaft is offset when the vehicle is in a vehicle steady state.

In a third aspect of the disclosure there is provided a steer-by-wire steering assembly for a vehicle comprising: a housing; at least one electronic control unit; a motor assembly having at least one rotor and at least one stator and the at least one electronic control unit is configured to control the motor assembly; an actuator operatively coupled to the at least one rotor; a steering shaft connectable to a first tie rod and a second tie rod, the steering shaft configured to engage with the actuator and to move longitudinally with respect to the housing when the motor assembly is actuated; a steering shaft displacement sensor and configured to send a signal to the at least one electronic control unit in dependence of detecting a reference target of the steering shaft; wherein the electronic control unit is configured to determine a rotation of a wheel and in dependence of the received signal from the steering shaft displacement sensor determine that a displacement of the steering shaft is offset in dependence of the rotation of the wheel.

Optionally, the at least one electronic control unit is configured to determine rotation of the wheel from one or more of a wheel rotation sensor or an indication of wheel rotation.

Optionally, the at least one electronic control unit is configured to determine that the variation of the offset is a first order response with respect to the rotation of the wheel.

Optionally, the at least one electronic control unit is configured to determine that the wheel is out of balance.

In a fourth aspect of the disclosure there is provided a steer-by-wire steering assembly for a vehicle comprising: a housing; at least one electronic control unit; a motor assembly having at least one rotor and at least one stator and the at least one electronic control unit is configured to control the motor assembly; an actuator operatively coupled to the at least one rotor; a steering shaft connectable to a first tie rod and a second tie rod, the steering shaft configured to engage with the actuator and to move longitudinally with respect to the housing when the first motor winding and/or the second motor winding is actuated; a steering shaft displacement sensor and configured to send a signal to the at least one electronic control unit in dependence of detecting a reference target of the steering shaft; at least one tire pressure sensor or tire pressure loss sensor configured to generate a pressure signal of a wheel mounted to the first tie rod or the second tie rod; wherein the electronic control unit is configured to determine a vehicle steady state condition, determine a steering shaft offset from the received signal from the steering shaft displacement sensor, and determine a fault condition of the at least one tire pressure sensor on the basis of the determined vehicle steady state condition and the determined steering shaft offset.

### BRIEF DESCRIPTION OF THE DRAWINGS

Various other aspects and further examples are also described in the following detailed description and in the attached claims with reference to the accompanying drawings, in which:

FIG. 1 shows a perspective view of a steering assembly according to an example;

FIG. 2 shows a cross-sectional side view of a steering assembly according to an example;

FIG. 3 shows a partial perspective view of a steering assembly according to an example;

FIG. 4 shows a side cross-sectional view of the steering assembly according to an example;

FIGS. 5a and 5b show schematic front views of the steering assembly with different vehicle conditions according to an example;

FIG. 6 shows a close-up schematic front view of the steering assembly as shown in FIG. 5b;

FIG. 7 shows a schematic representation of the steering assembly according to an example;

FIG. 8 shows a flow diagram of operation of the steering assembly according to an example;

FIG. 9 shows a graph of parameters of the steering assembly during operation according to an example.

### DETAILED DESCRIPTION

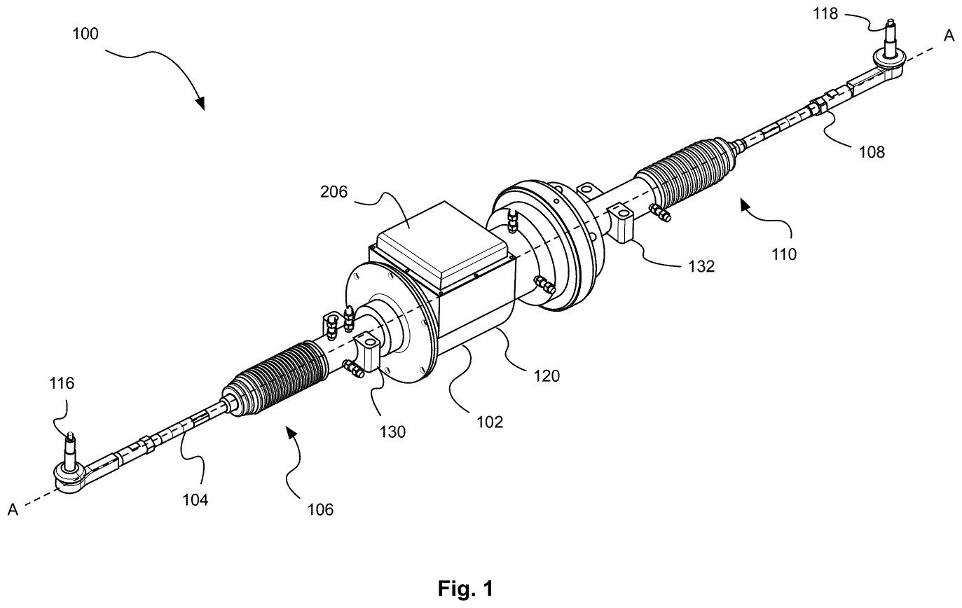

FIG. 1 shows a perspective view of a steering assembly 100. The steering assembly 100 comprises a main housing 102 and one or more components of the steering assembly 100 are mounted within the main housing 102. The steering assembly 100 is generally elongate in construction and extends along a longitudinal axis A-A. As discussed below, one or more components of the steering assembly 100 are aligned along the longitudinal axis A-A.

The steering assembly 100 as shown in FIG. 1 is coupled to a first tie rod 104 at a first steering assembly end 106 of the steering assembly 100. The steering assembly 100 is also coupled to a second tie rod 108 at a second steering assembly end 110 of the steering assembly 100.

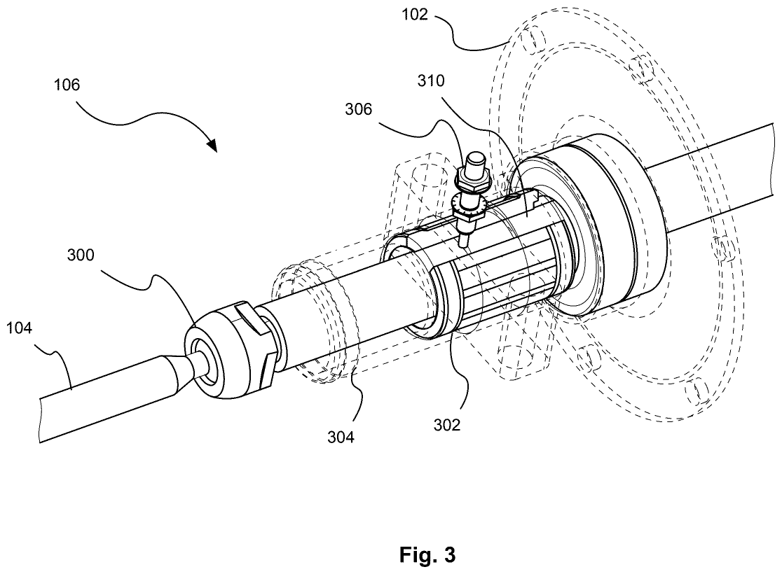

The steering assembly 100 is coupled to the first tie rod 104 with a first tie rod coupling 300 (best shown in FIG. 3.). FIG. 3 shows a partial perspective view of the steering assembly 100 at the first steering assembly end 106. The steering assembly 100 is also coupled to the second tie rod 108 with a second tie rod coupling (not shown). In some examples, both the first tie rod coupling 300 and the second tie rod coupling are ball joints.

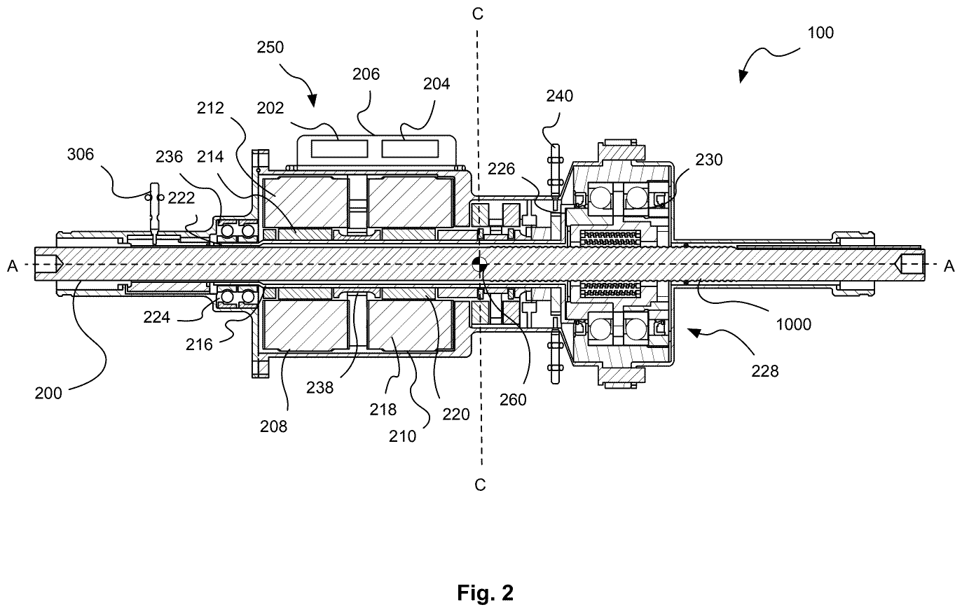

The steering assembly 100 comprises a steering shaft 200 (best shown in FIG. 2.) FIG. 2 shows a side cross-sectional view of the steering assembly 100. The steering shaft 200 is configured to move in a linear direction along the longitudinal axis A-A with respect to the main housing 102. In some examples, the longitudinal axis of the steering shaft 200 is aligned with the longitudinal axis A-A of the steering assembly 100 e.g., coaxial with the longitudinal axis A-A of the steering assembly 100. In some other examples, the longitudinal axis of the steering shaft 200 extends in a direction parallel to the longitudinal axis A-A of the steering assembly 100.

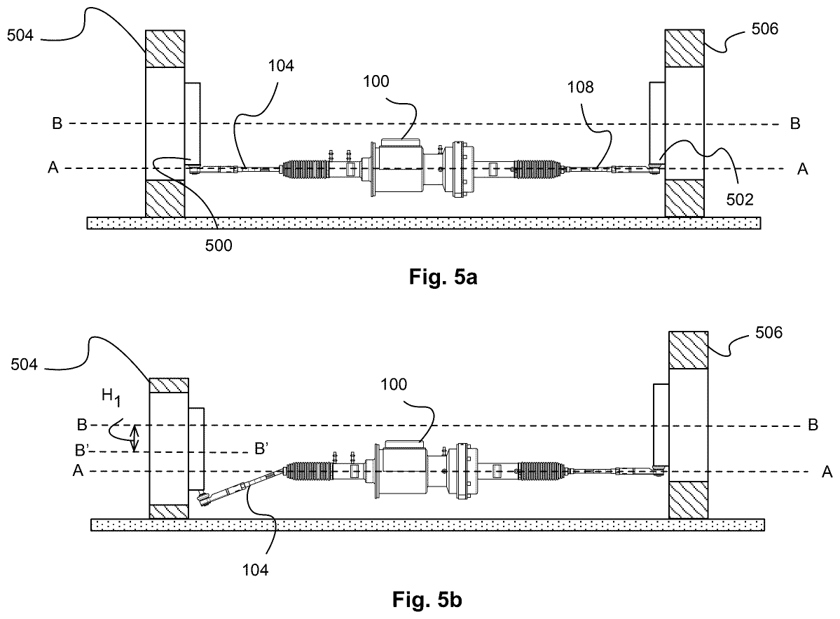

The first and second tie rods 104, 108 are respectively connected to a first tie rod end 116 and a second tie rod end 118. The first and second tie rod ends 116, 118 are configured to be respectively pivotally connected to a first and second steering knuckle 500, 502, for example this may be a ball-joint (as schematically shown in FIG. 5a). The first and second tie rods 104, 108 and the first and second steering knuckles 500, 502 are known and will not be discussed in any further detail.

As shown in FIG. 1, in some examples, the main housing 102 comprises a plurality of different housing portions with differing diameters. The different housing portions in some examples are separate elements and mountable to each other. This may make assembly during manufacturing easier. For example, an ECU housing 206 is mounted to the main housing 102. The main housing 102 is mountable to a vehicle structure (not shown) e.g., a chassis via a first and second mounting connections 130, 132.

In some examples, the vehicle is an electric vehicle e.g., an electric car or electric truck. In some other examples, the vehicle is a vehicle with an internal combustion engine or any other type of motorised vehicle. The steering assembly 100 as discussed in reference to the accompanying Figs can optionally be used with any suitable vehicle with at least one steerable wheel.

In some examples, the steering assembly 100 is a steer-by-wire steering assembly 100. The term steer-by-wire means that there is no mechanical linkage between a user input e.g., a steering wheel (not shown) or control input device and the steering assembly 100. For example, the steering assembly 100 does not comprise a steering wheel connected to a rack and pinion mechanism (not shown).

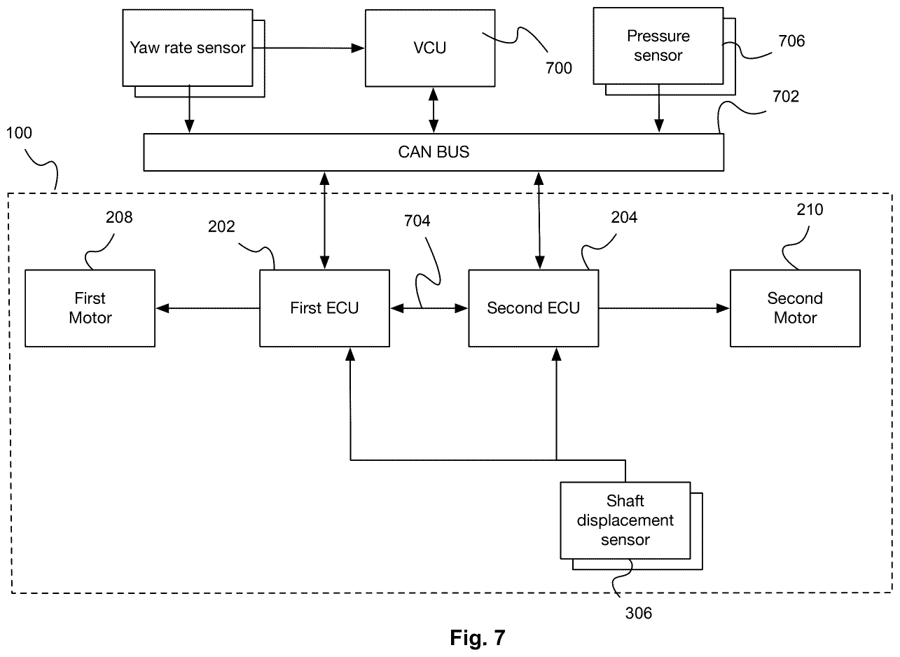

Instead, control instructions are provided from one or more electronic control units (ECU) 202, 204 configured to control the steering assembly 100. As mentioned above, the first and second ECUs 202, 204 are mounted in an ECU housing 206. The ECU housing 206 is mounted to the main housing 102. In some other examples, the ECU housing 206 is mounted in a separate location to the steering assembly 100 or remote from the main housing 102 connected by data and power connections to the steering assembly 100 as shown in the Figs. The first and second ECUs 202, 204 optionally receive control instructions from a vehicle control unit (VCU) 700 (best shown in FIG. 7) or another device connected to a controller area network (CAN) BUS 702 of the vehicle. In some examples, the VCU 700 can be a vehicle motion controller (VMC). Data connections to and from the first and second ECUs 202, 204 to the CAN BUS 702 are shown in FIG. 7. In some less preferred examples, the steering assembly 100 is optionally configured to receive control instructions directly from the VCU 700 and there are no ECUs 202, 204.

Hereinafter reference to the steer-by-wire steering assembly 100 will be made using the term “steering assembly 100”.

In some examples, the steering assembly 100 is controlled in response to control instructions from a user input e.g., an electrically connected steering wheel. Alternatively other user input devices can be used with the steering assembly 100 e.g., a joystick, or any other suitable user input control device.

Additionally, or alternatively, the steering assembly 100 is controlled from control instructions received from the first or second ECUs 202, 204 or the VCU 700. For example, the steering assembly 100 is optionally a subassembly of an autonomous vehicle. However, even if the steering assembly 100 is used in an autonomous vehicle, it may be preferable to allow control of the steer-by-wire steering assembly 100 from a user input device e.g., an electrically connected steering wheel. This will permit user-controlled testing and review of the steering assembly 100 in an autonomous vehicle on the roads.

Turning to FIG. 2, the steering assembly 100 will be discussed in more detail.

The steering assembly 100 comprises a motor assembly 250 having first motor 208 and a second motor 210. The first motor 208 and the second motor 210 are mounted within the motor housing portion 120. In some examples, the first motor 208 is controlled by the first ECU 202 and the second motor 210 is controlled by the second ECU 204.

Additionally, or alternatively, either the first motor 208 and/or the second motor 210 is configured to receive control instructions from any of the first or second ECUs 202, 204 or the VCU 700. Reference hereinafter to the control of the steering assembly 100 is made in reference to the first ECU 202 and the second ECU 204 issuing control instructions to the first motor 208 and the second motor 210. The first ECU 202 is configured to issue control instructions to either the first motor 208 and/or the second motor 210. Similarly, the second ECU 204 is configured to issue control instructions to either the first motor 208 and/or the second motor 210. The first ECU 202 and the second ECU 204 can operate independently of each other or alternatively together in unison. This means that control functionality discussed in the present disclosure with respect to the first ECU 202 is applicable to the second ECU 204 as well.

In some preferred examples, the first ECU 202 is configured to control the first motor 208 and the second ECU 204 is configured to control the second motor 210. The first and second ECUs 202, 204 are connected with an ECU data connection 702 (as shown in FIG. 7) and are configured to communicate an operational status to each other via the ECU data connection 702. Alternatively, communication between the first ECU 202 and the second ECU 204 is via the CAN BUS 702. The first and second ECUs 202, 204 are configured to transmit and receive fault states to either the other ECUs 202, 204 and/or the VCU 700. In this way, the first ECU 202 can determine whether there is a fault state with the second ECU 204 or the second motor 210 from system status messages sent from the second ECU 204. Similarly, the second ECU 204 can determine whether there is a fault state with the first ECU 202 or the first motor 208 from system status messages sent from the first ECU 202. Reference is made to the CAN BUS 702, hereinafter, but any suitable data connection (including a wireless data connection or a wired data connection) can be used between the first and second ECUs 202, 204 and the other components of the vehicle e.g. VCU 700, steering shaft displacement sensor 306, tire pressure sensors 706 etc.

In the event that e.g., the second ECU 204 or the second motor 210 experiences a fault or malfunction, the second ECU 204 either sends a system status message comprising a fault indication to the first ECU 202 or no system status message is sent. On receipt of the system status message comprising a fault indication or the first ECU 202 determining that no system status message has been received, the first ECU 202 determines that there is a fault or malfunction with the second ECU 204 or the second motor 210. Accordingly, the first ECU 202 assumes total control of the steering assembly 100 and the first ECU 202 issues control instructions to the first motor 208. In this way, the first ECU 202 and the first motor 208 can still operate the steering assembly 100 when either the second ECU 204 or the second motor 210 have failed. The second ECU 204 comprises a similar functionality to the first ECU 202 and is configured to assume total control of the steering assembly 100 if the second ECU 204 determines that either the first ECU 202 or the first motor 208 has failed.

One or all of the first ECU 202, the second ECU 204 and/or the VCU 700 may be at least partially implemented by software executed by a processing unit. The first ECU 202, the second ECU 204 and/or the VCU 700 may be configured as separate units, or they may be incorporated in a single unit. One or all of the first ECU 202, the second ECU 204 and/or the VCU 700 may be at least partially implemented by software executed by the processing unit.

The processing unit of the first ECU 202, the second ECU 204 and/or the VCU 700 may be implemented by special-purpose software (or firmware) run on one or more general-purpose or special-purpose computing devices. In this context, it is to be understood that each “element” or “means” of such a computing device refers to a conceptual equivalent of a method step; there is not always a one-to-one correspondence between elements/means and particular pieces of hardware or software routines. One piece of hardware sometimes comprises different means/elements. For example, a processing unit may serve as one element/means when executing one instruction but serve as another element/means when executing another instruction. In addition, one element/means may be implemented by one instruction in some cases, but by a plurality of instructions in some other cases. Naturally, it is conceivable that one or more elements (means) are implemented entirely by analogue hardware components.

The processing unit may include one or more processing units, e.g., a CPU (“Central Processing Unit”), a DSP (“Digital Signal Processor”), an ASIC (“Application-Specific Integrated Circuit”), discrete analogue and/or digital components, or some other programmable logical device, such as an FPGA (“Field Programmable Gate Array”). The processing unit may further include a system memory and a system bus that couples various system components including the system memory to the processing unit. The system bus may be any of several types of bus structures including a memory bus or memory controller, a peripheral bus, and a local bus using any of a variety of bus architectures. The system memory may include computer storage media in the form of volatile and/or non-volatile memory such as read only memory (ROM), random access memory (RAM) and flash memory. The special-purpose software and associated control parameter values may be stored in the system memory, or on other removable/non-removable volatile/non-volatile computer storage media which is included in or accessible to the computing device, such as magnetic media, optical media, flash memory cards, digital tape, solid state RAM, solid state ROM, etc. The processing unit may include one or more communication interfaces, such as a serial interface, a parallel interface, a USB interface, a wireless interface, a network adapter, etc, as well as one or more data acquisition devices, such as an A/D converter. The special-purpose software may be provided to the processing unit on any suitable computer-readable medium, including a record medium, and a read-only memory.

The first motor 208 comprises a first stator 212 and a first rotor 214. The term “motor” means a set of motor windings mounted in a stator which is configured to rotate at least one rotor when energised. The first stator 212 comprises one or more motor windings configured to cause the first rotor 214 to rotate when energised. The first rotor 214 is mounted on a rotor carrier sleeve 216 and the rotor carrier sleeve 216 is configured to rotate when the first rotor 214 rotates. The first rotor 214 is fixed with respect to the rotor carrier sleeve 216. In some examples the first rotor 214 is press-fit onto the rotor carrier sleeve 216. In some alternative examples, a tolerance ring (not shown) is used instead of a press fit. A tolerance ring may be beneficial because a tolerance ring is easier to install with less force and this reduces the risk of surface damage to the rotor carrier sleeve 216 when assembled.

The second motor 210 comprises a second stator 218 and a second rotor 220. The second stator 218 comprises one or more motor windings configured to cause the second rotor 220 to rotate when energised. The second rotor 220 is also mounted on the rotor carrier sleeve 216 and the rotor carrier sleeve 216 is configured to rotate when the second rotor 220 rotates. The second rotor 220 is also fixed with respect to the rotor carrier sleeve 216. In some examples, similarly the second rotor 220 is press-fit onto the rotor carrier sleeve 216.

In some other examples, the motor assembly 250 comprises only a first stator 212 which comprises a first set of motor windings and a second set of motor windings. The first stator 212 with first and second sets of motor windings is configured to rotate the first rotor 214 when either the first or second sets of motor windings are energised. In this example, there is only a single first rotor 214. Indeed, either the first set of motor windings or the second set of motor windings is configured to rotate the first rotor 214 when energised. In this example, the first motor 208 can be considered to be a combination of the first stator 212 with the first set of motor windings and the first rotor 214. The second motor 210 can be considered to be a combination of the first stator 212 with the second set of motor windings and the first rotor 214.

In another example, the first motor 208 and the second motor 210 respectively comprise a first stator 212 and a second stator 218 but share a common first rotor 214. In this case, the first rotor 214 is common to both the first and second motors 208, 210. Accordingly, the first motor 208 can be considered to be a combination of the first stator 212 with the first set of motor windings and the first rotor 214. The second motor 210 can be considered to be a combination of the second stator 218 with the second set of motor windings and the first rotor 214.

In another example, the motor assembly 250 comprises a first stator 212 which comprises a first set of motor windings and a second set of motor windings in combination with the first rotor 214 and the second rotor 220. The first stator 212 with the first set of motor windings is configured to rotate the first rotor 214 when energised. The first stator 212 with second set of motor windings is configured to rotate the second rotor 220 when energised. In this example, the first motor 208 can be considered to be a combination of the first stator 212 with the first set of motor windings and the first rotor 214. The second motor 210 can be considered to be a combination of the first stator 212 with the second set of motor windings and the second rotor 220.

The first and second motors 208, 210 in other examples can have any suitable number of sets of motor windings e.g., two, three, four etc sets of motor windings with multiple phases e.g., 3 or 6 phases.

It should be noted that the previously discussed variations in the motor assembly 250 and the first and second motors 208, 210 and the arrangement of the first and second stators 212, 218 and the first and second rotors 214, 220 are applicable to any of the examples discussed in reference to the Figures.

The first and second motors 208, 210 in some examples are induction motors. In some other examples the first and second motors 208, 210 are any other suitable type of electric motor e.g., a brushless DC electric motor (BLDC), synchronous motor, 3 phase induction motor etc.

The preferred examples as shown in FIG. 2 will now be discussed in more detail. That is, the first motor 208 comprising the first stator 212 and the first rotor 214 and the second motor 210 comprising the second stator 218 and the second rotor 220.

In this way, either the second motor 210 or the first motor 208 are configured to cause rotation of the rotor carrier sleeve 216. Accordingly, the second motor 210 or the first motor 208 are configured to provide a torque and rotational speed to the rotor carrier sleeve 216. For example, if one of the first motor 208 or the second motor 210 develops a fault, the other of the first motor 208 or the second motor 210 can still rotate the rotor carrier sleeve 216. A “fault” means anything relating to operation of the ECUs, sensors, or motors 208, 210. For example, the second ECU 204, the second motor 210 or one or more sensors develop a fault. The part of the steering assembly 100 comprising the second ECU 204 and the second motor 210 then shuts down and the first ECU 202 is configured to provide functionality by issuing control instructions to the first motor 208. This means that the steering assembly 100 is operational even if one of the first or second motor 208, 210 is not operational. Accordingly, this provides fail-operational redundancy.

Whilst FIG. 2 shows a first motor 208 and a second motor 210 in the steering assembly 100, in other examples there can be any suitable number of motors mounted within the motor housing portion 120. Furthermore, as previously mentioned there can be multiple motor windings. This means in some examples there can be one physical motor but multiple separate electrical motor circuits providing separate motor functionality. For example, there can be three motors, four motors etc. The first and second motors 208, 210 as shown in FIG. 2 are adjacent to each other within the motor housing portion 120.

The rotor carrier sleeve 216 is an elongate tube which extends along the longitudinal axis A-A. The rotor carrier sleeve 216 is rotatable about the steering shaft 200. The rotor carrier sleeve 216 is coaxial with the steering shaft 200. A first sleeve end 222 of the rotor carrier sleeve 216 is rotatably mounted to the main housing 102 via a rotor carrier sleeve bearing 224.

A second sleeve end 226 of the rotor carrier sleeve 216 is connected to a screw actuator 228. The screw actuator 228 is mounted in the main housing 102. Similar to the rotor carrier sleeve bearing 224, the screw actuator 228 is press-fit into the main housing 102. The screw actuator 228 is configured to engage with a threaded portion 1000 of the steering shaft 200.

When the screw actuator 228 rotates, the screw actuator 228 is configured to cause a linear displacement of the steering shaft 200 along the longitudinal axis A-A. Depending on the direction of rotation of the screw actuator 228, the steering shaft 200 moves in a direction towards the first steering assembly end 106 or a direction towards the second steering assembly end 110. Accordingly, the torque, direction, and speed that the first and/or second motor 208, 210 rotate determines the speed, direction, and magnitude of the linear displacement of the steering shaft 200.

As shown in FIG. 2 the screw actuator 228 is in some examples a planetary roller screw 230. In some other examples, the screw actuator 228 is a ball screw bearing (not shown) configured to engage the threaded portion 1000. In some other examples, the screw actuator 228 is any suitable rotating mechanism configured to engage one or more parts of the groove of the threaded portion 1000 whilst rotating. In FIG. 2 there is an integrated roller screw 230 with a rotating nut and bearing. However, in some other examples, there can be a separate roller screw and nut which is pressed into a bearing.

In order for the first and second ECUs 202, 204 to determine the status of one or more components of the steering assembly 100, the steering assembly 100 comprises at least one steering shaft displacement sensor 306 connected to the first and second ECUs 202, 204. The steering shaft displacement sensor 306 is configured to generate and send a signal to the first and/or second ECU 202, 204. The first and/or second ECUs 202, 204 are configured to determine the linear displacement of the steering shaft 200 with respect to the main housing 102 on the basis of the received signal from the steering shaft displacement sensor 306.

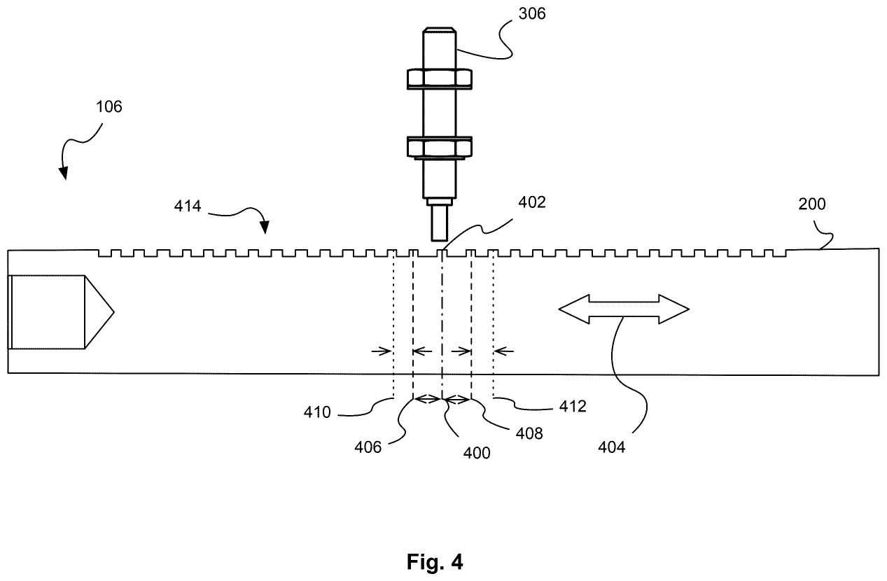

The steering shaft displacement sensor 306 will now be described in more detail with respect to FIG. 3 and FIG. 4. FIG. 3 shows a partial perspective view of the steering assembly 100 at the first steering assembly end 106. FIG. 4 shows a close-up side cross-sectional view of the steering assembly 100.

As shown in FIG. 3 the first steering assembly end 106 of the main housing 102 comprises a steering shaft displacement sensor 306. In some examples, the steering shaft displacement sensor 306 is a cross centre sensor 306. That is the steering shaft displacement sensor 306 is configured to detect movement of a centre reference target 400 with respect to a geometric centre C of the steering assembly 100 e.g., detecting movement of the steering shaft 200 as it moves from a centrally aligned position. The steering shaft displacement sensor 306 is mounted in the first housing sleeve portion 304.

The steering shaft displacement sensor 306 will be described in more detail in FIG. 3. FIG. 3 shows that the first steering shaft bearing 302 comprises an elongate channel 310. The first steering shaft bearing 302 can comprise a unitary construction or may comprise a plurality of bearing parts. The elongate channel 310 in the first steering shaft bearing 302 allows access to the steering shaft 200 for the steering shaft displacement sensor 306. Alternatively, the steering shaft displacement sensor 306 can be mounted in a different position on the main housing 102 so that the steering shaft displacement sensor 306 does not protrude through the elongate channel 310 of the first steering shaft bearing 302. In all the examples, the steering shaft displacement sensor 306 is fixed with respect to the main housing 102. This means that the steering shaft displacement sensor 306 is configured to detect relative movement of the steering shaft 200 with respect to the main housing 102.

In some examples, the steering shaft displacement sensor 306 is configured to generate a sensor signal based on the absolute positional information of the steering shaft 200 with respect to the main housing 102. The steering shaft displacement sensor 306 is configured to detect a centre reference target 400. In particular, the steering shaft displacement sensor 306 is configured to detect the centre reference target 400, when a midpoint 260 of the steering shaft 200 is aligned with the geometric centre C of the steering assembly 100. The midpoint 260 of the steering shaft 200 aligned with the geometric centre C of the steering assembly 100 is shown in FIG. 2. This means that when the midpoint 260 of the steering shaft 200 is aligned with the geometric centre C of the steering assembly 100, the steering assembly 100 is in a “straight ahead” position. In normal operation, the wheels mounted on the steering assembly 100 will have a zero turning angle and be in the straight-ahead position. This is schematically represented in FIG. 5a.

FIG. 4 shows a schematic representation of the steering shaft displacement sensor 306 positioned above the steering shaft 200. The steering shaft displacement sensor 306 is configured to detect the centre reference target 400. As mentioned previously, the centre reference target 400 is not the midpoint 260 of the steering shaft 200. The centre reference target 400 in FIG. 4 is optionally a projecting tooth or reference notch 402 from the steering shaft 200 which is aligned with the centre reference target 400.

As shown in FIG. 3, the steering shaft displacement sensor 306 is mounted on the first housing sleeve portion 304 at the first steering assembly end 106 of the main housing 102. The steering shaft displacement sensor 306 is not positioned above the geometric centre C of the steering assembly 100 as shown in FIG. 3. In some less preferred examples, the steering shaft displacement sensor 306 is mounted above the geometric centre C of the steering assembly 100. However, in more preferred examples, the steering shaft displacement sensor 306 is mounted away from the geometric centre C which provides more space for the other components of the steering assembly 100. This means that the heavier components of the steering assembly 100 such as the first and second motor 208, 210 are mounted in the centre of the steering assembly 100. This helps the stability of the vehicle in which the steering assembly 100 is mounted.

The steering shaft displacement sensor 306 is configured to generate a shaft centre signal when the centre reference target 400 moves past the steering shaft displacement sensor 306. In some examples, the centre reference target 400 is a magnet, a reference notch 402 or recess in the steering shaft 200, or a projecting peg from the steering shaft 200. In some examples, the steering shaft displacement sensor 306 is a hall-effect sensor configured to detect e.g., the magnet, the reference notch 402 or recess in the steering shaft 200, or the projecting peg from the steering shaft 200.

Whilst the examples as shown in the Figs show a hall-effect sensor, in other examples the steering shaft displacement sensor 306 can be any other suitable sensor. For example, the steering shaft displacement sensor 306 can be an optical sensor configured to detect a centre reference indication mark on the steering shaft 200. In some other examples, the centre reference target 400 comprises a projecting finger (not shown) and the steering shaft displacement sensor 306 is a mechanical switch, a pressure sensor or a force sensor which is configured to generate a shaft centre signal e.g., actuate the mechanical switch when the projecting finger moves past the centre reference target 400.

The steering shaft displacement sensor 306 as shown and described in reference to FIG. 3 is a simple way to determine the absolute position of the steering shaft 200 with the steering assembly 100.

FIG. 3 shows a specific implementation of a steering shaft displacement sensor 306. In some other examples, the displacement of the steering shaft 200 can be determined by the first or second ECU 202, 204 with any other type of sensor suitable for detecting linear displacement of the steering shaft 200 with respect to the main housing 102. For example, the first or second ECU 202, 204 can receive a signal from a rotational sensor corresponding to the rotational movement of the first or second rotor 214, 220. The first or second ECU 202, 204 can then determine the linear displacement of the steering shaft 200 from the rotational signal e.g., the speed and direction of the first or second rotor 214, 220 and stored parameters of the steering shaft 200 e.g., the gearing of the screw actuator 228.

Optionally, the steering shaft displacement sensor 306 as shown in FIG. 3 can be configured to additionally detect a plurality of reference notches 402 on the steering shaft 200. The plurality of reference notches 402 form a linear tooth pattern 414 on the steering shaft 200. As each reference notch 402 passes the steering shaft displacement sensor 306, the steering shaft displacement sensor 306 is configured to generate the centre shaft signal and send the centre shaft signal to the first or second ECU 202, 204. The first or second ECU 202, 204 can then also determine the distance to steering shaft 200 has moved from the geometric centre C of the steering assembly 100

In some examples, the steering shaft displacement sensor 306 is configured to vary a generated signal in dependence the position of the steering shaft displacement sensor 306 with respect to the linear tooth pattern 414. For example, the spacing and size of the notches vary along the length of the linear tooth pattern 414.

The linear tooth pattern 414 comprises a different pattern immediately about the centre reference target 400. The linear tooth pattern 414 comprises primary adjacent reference targets 406, 408 which are positioned immediately either side of the centre reference target 400. The distance between the primary adjacent reference targets 406, 408 and the centre reference target 400 is larger than the spacing between other targets 410, 412. This means that the centre reference target 400 is configured to generate a unique shaft centre signal in dependence of the steering shaft 200 position with respect to the main housing 102 near the centre reference target 400.

Accordingly, the steering shaft displacement sensor 306 is configured to generate a shaft centre signal when the centre reference target 400 moves in either direction along the longitudinal axis A-A as shown by arrow 404.

As mentioned above, when the steering assembly 100 is in the straight-ahead position, the first or second ECU 202, 204 receives the shaft centre signal indicating that the midpoint 260 of steering shaft 200 is centrally aligned. The first or second ECU 202, 204 then determines that the linear displacement of the steering shaft 200 is zero when receiving the shaft centre signal. This means that the first or second ECU 202, 204 knows with certainty that the steering shaft 200 is centrally aligned.

At the same time the first or second ECU 202, 204 is optionally configured to determine rotational signal information by e.g. from a received signal from a rotational sensor 240. The rotational sensor 240 is configured to detect rotational movement of one or more rotating components of steering assembly 100 e.g. the first and/second motors 208, 210 etc. Accordingly, the first or second ECU 202, 204 determines the rotational displacement of one or more rotational components of the steering assembly 100. By combining the signal received from the steering shaft displacement sensor 306 with rotational information of the motor assembly 250, the first or second ECUs 202, 204 can determine the magnitude of the linear displacement of the steering shaft 200.

The first or second ECU 202, 204 may optionally receive rotational information from the first or second motors 208, 210. For example, the first and second motors 208, 210 comprise data connections to the first or second ECUs 202, 204 and the status information of the first and second motors 208, 210 is received at the first or second ECUs 202, 204. Additionally, or alternatively, the first or second ECUs 202, 204 receive rotational information from the at least one rotational sensor 240.

In some other examples, the first or second ECU 202, 204 do not receive rotational information from the first and second motors 208, 210 or the at least one rotational sensor 240. Instead, the first or second ECUs 202, 204 determine the rotational information of the first and second motors 208, 210 based on control instructions sent to the first and second motors 208, 210.

The first ECU 202 or second ECU 204 then receives steering assembly parameters. The receiving of the steering assembly parameters can comprise retrieving parameters of the steering assembly 100 from memory. For example, the steering assembly parameters are stored in a lookup table in memory. The steering assembly parameters are the gearing factor of the screw actuator 228. The gearing factor of the screw actuator 228 determines how far the steering shaft 200 moves with respect to the main housing 102 for every complete revolution of the first or second motor 208, 210.

The first ECU 202 or second ECU 204 determines the linear displacement of the steering shaft 200 based on the steering assembly parameters and the determined rotational signal information. For example, the first ECU 202 or second ECU 204 multiples the number of revolutions of the first or second motor 208, 210 and the gearing factor to determine the linear displacement of the steering shaft 200.

The first ECU 202 or the second ECU 204 keeps monitoring and determining the linear displacement of the steering shaft 200. As mentioned above, periodically the first ECU 202 or second ECU 204 receives the shaft centre signal from the steering shaft displacement sensor 306.

In some scenarios other components of the vehicle can affect the steering assembly 100. This means that the steer-by-wire steering assembly 100 can determine one or more faults with the wheels or other components of the vehicle with the steering shaft displacement sensor 306 detecting the relative position of the steering shaft 200. For example, the steering shaft displacement sensor 306 detecting the displacement of the midpoint 260 of the steering shaft 200 from the geometric centre C of the steering assembly 100 can be used to determine fault conditions of a wheel such as low tire pressure. This means that the steering assembly 100 can provide additional sensor redundancy for determining the tire pressure. In the event that a tire pressure sensor 706 fails, the vehicle can still determine that there is a fault condition with a wheel. This allows steer-by-wire steering assembly 100 to provide additional fail operational redundancy to other parts of the vehicle.

FIG. 5a shows a schematic representation of the steering assembly 100 operating under normal conditions. FIG. 5a shows a first wheel 504 connected to the first tie rod 104 and a second wheel 506 connected to the second tie rod 108. The first and second steering knuckles 500, 502 are schematically represented. The first and second wheels 504, 506 are inflated to the correct tire pressure and there are no fault conditions with the vehicle. The first and second wheels 504, 506 rotate about a first axis of rotation B-B during normal operation. FIG. 5a also shows the longitudinal axis A-A of the steering assembly 100 for comparison.

FIG. 5b shows the representation of the steering assembly 100 when a fault scenario arises. Here, the first wheel 504 has a low tire pressure because e.g., the first wheel 504 has a puncture. This means that the second wheel 506 still rotates about the first axis of rotation B-B, but the first wheel 504 now rotates about a second axis of rotation B′-B′. The second axis of rotation B′-B′ is at a lower height than the first axis of rotation B-B because the tire wall of the first wheel 504 is lower due to the low tire pressure. Accordingly, the second axis of rotation B′-B′ is lower than the first axis of rotation B-B by a height H₁.

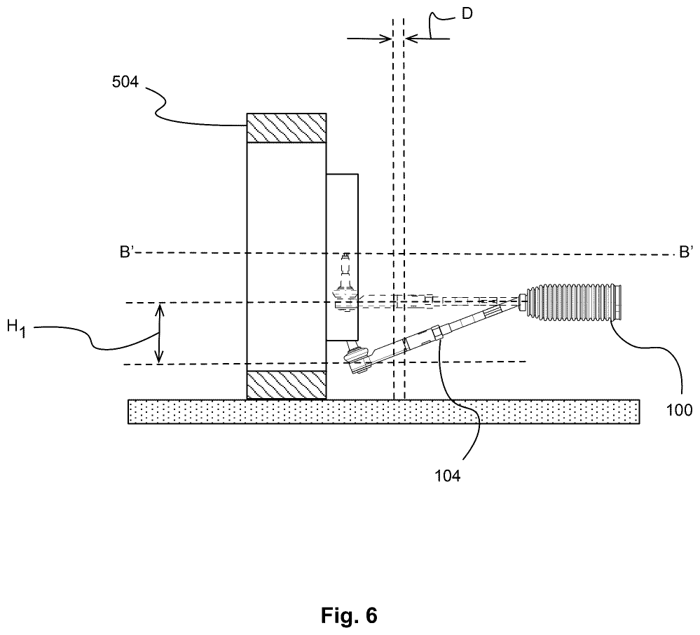

Since the first wheel 504 now rotates about a second axis of rotation B′-B′, the first tie rod 104 is also moved lower by height H₁ as shown in FIG. 6. Accordingly, the lateral position of the first tie rod 104 and the steering shaft 200 with respect to the main housing 102 also changes. As shown in FIG. 6, the lateral position of the steering shaft 200 moves by distance D. This means that the midpoint 260 of the steering shaft 200 will be offset by distance D from the geometric centre C of the steering assembly 100. This means that the steering assembly 100 and the vehicle experiences a lateral drift due to the flat tire.

With the first wheel 504 having an under inflated tire, the effective horizontal vector of the length of the first tie rod 104 is reduced. The first and second wheels 504, 506 position are fixed about a king-pin axis and there is a shorter effective total steering length between the first and second wheels 504, 506. This causes the steering assembly 100 to create a steering angle on the first and second wheels 504, 506. If the vehicle comprises a Castor or Ackerman steering geometry, this will mean that the imbalance is taken up equally between the first and second wheels 504, 506 and a resulting steering effect e.g., the steering assembly 100 experiences a steering drift. This means that steering corrections in the steering assembly 100 are required to correct this steering effect to maintain a straight-ahead position for the vehicle. In other words, this would create an offset between the geometric centre C of the steering assembly 100 and the midpoint 260 of the steering shaft 200 when in a straight-ahead position.

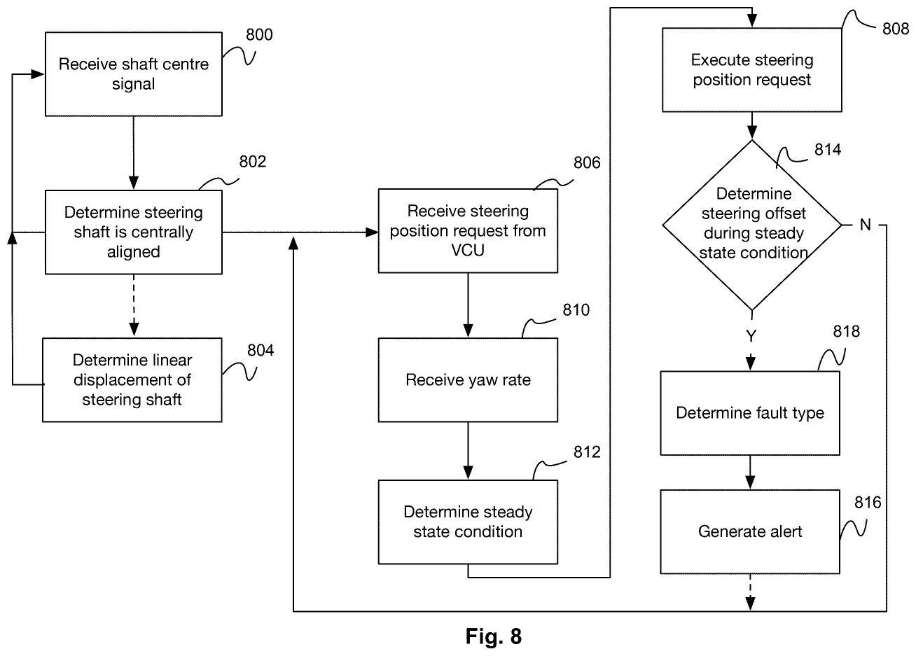

Discussion will now be made to the method of the steering assembly 100 detecting a fault condition with reference to FIG. 8 which shows flow diagram.

During normal operation, the first and/or second ECU 202, 204 is configured to receive the shaft centre signal from the steering shaft displacement sensor 306 as shown in step 800. The first and/or second ECU 202, 204 then determines in step 802 that the steering shaft 200 is centrally aligned. The first and/or second ECU 202, 204 knows with certainty that the midpoint 260 of the steering shaft 200 is aligned with the geometric centre C of the steering assembly 100. This process is repeated and as the vehicle moves and turns, the first and/or second ECU 202, 204 will periodically determine that the steering shaft 200 is centrally aligned. Between subsequent received shaft centre signals, the first and/or second ECU 202, 204 can optionally determine the magnitude of the displacement based on rotational information of the screw actuator 228 as mentioned above as shown in step 804.

Whilst the previous examples disclose the first and/or second ECU 202, 204 receiving a signal indicating the yaw rate of the vehicle, in some other examples the first and/or second ECU 202, 204 do not receive an indication of the yaw rate. Instead, the first and/or second ECU 202, 204 determine the whether the vehicle is in a steady state condition e.g. in a straight-ahead position from other information. In some examples, the first and/or second ECU 202, 204 that the vehicle is moving in a straight head direction when the command from the VCU 700 remains constant for a predetermined period of time. In some examples, the predetermined period of time is 1s, 2s, 3s, 4s, 5s or any other suitable period of time. Since the vehicle will not drive for more than a few seconds with a constant steering angle, the first and/or second ECU 202, 204 determine a straight head position if no request for a steering angle is received after the predetermined period of time). Accordingly, the first and/or second ECU 202, 204 can determine when the vehicle is in steady state condition, e.g. a straight ahead position and determine the offset between geometric centre and the actual steering shaft position without the yaw rate data of the vehicle.

In step 806, the first and/or second ECU 202, 204 receives a steering position request. The steering position request is received from the VCU 700 or the VMC. The steering position request is an instruction for the first or second ECU 202, 204 for a required steering angle of the steering assembly 100. When the first or second ECU 202, 204, receives the steering position request in step 806, the first or second ECU 202, 204 also optionally perform a condition check of the steering assembly 100 to detect if a fault condition of the steering assembly 100 or the first and second wheels 504, 506 occurs.

The first and second ECUs 202, 204 can perform the steps of checking for a fault condition automatically when a steering position request is received from e.g., the VCU 700. This means the first and second ECUs 202, 204 are constantly checking for a fault condition. Alternatively, or additionally, the first and second ECUs 202, 204 can receive a control instruction from the CAN BUS 702 e.g., from the VCU 700 that the first and second ECUs 202, 204 must perform a check for a fault condition. In this case, the VCU 700 can request a check from the first or second ECUs 202, 204 for a fault condition. This may be because the VCU 700 is confirming whether a fault condition is present.

When the first or second ECU 202, 204 receives the steering position request, the first or second ECU 202, 204 executes the steering position request as shown in step 808 by actuating the first motor 208 or the second motor 210. The first or second ECUs 202, 204, control the first and second motors 208, 210 to move the steering shaft 200 as discussed above. This causes the first and second wheels 504, 506 to turn to a required steering angle. The step 808 can optionally be performed after the steps 810, 812 or before.

The first or second ECUs 202, 204 receive an indication of the yaw rate of the vehicle in step 810. The yaw rate is the rate that the vehicle is rotating about a vertical axis of the vehicle. The yaw rate is received by the first or second ECUs 202, 204 from the CAN BUS 702. The yaw rate may be broadcast on the CAN BUS 702 with a timestamp and the first or second ECUs 202, 204 can read this data. In some examples, the yaw rate is broadcast on the CAN BUS 702 in degrees per second or radians per second. Optionally, the first or second ECUs 202, 204 can also receive additional information relating to the operation of the vehicle in step 810. For example, the first or second ECUs 202, 204 optionally receive the rotational wheel speeds over the CAN BUS 702. Optionally, the first or second ECUs 202, 204 can also receive a pressure signal from a tire pressure sensor 706 e.g., via the CAN BUS 702.

In step 812, the first or second ECUs 202, 204 determine that the vehicle is in a vehicle steady state condition from the yaw rate. In most examples, the first or second ECUs 202, 204 determine that the vehicle is in a vehicle steady state condition when the yaw rate is 0 degrees per second. In this case, the first or second ECUs 202, 204 determine that the vehicle steady state condition is a “straight ahead” position.

As mentioned above, alternatively the first or second ECUs 202, 204 in step 812 do not use the yaw rate of the vehicle to determine a vehicle steady state condition. Instead, the first or second ECUs 202, 204 detect that no steering position request has been received from the VCU 700 for a predetermined period of time. Accordingly, the first or second ECUs 202, 204 infer from the absence of a received steering position request that the vehicle is in a straight-ahead position. This means that step 810 is optional and is not necessary.

When the first or second ECUs 202, 204 determine that the vehicle is in a vehicle steady state condition e.g., in a straight-ahead position, the first or second ECUs 202, 204 are configured to determine whether the steering shaft 200 is offset from the geometric centre C in step 814.

If the first or second ECUs 202, 204 determine that there is no offset of the steering shaft 200 during a vehicle steady state condition, then the first or second ECUs 202, 204 return to step 806 e.g., waiting for the next steering position request from the VCU 700.

If the first or second ECUs 202, 204 determine that there is an offset of the steering shaft 200, then the first or second ECUs 202, 204 generates a fault condition alert as shown in step 816. The fault condition alert is sent to the VCU 700 via the CAN BUS 702. Depending on the status of the vehicle, then the first or second ECUs 202, 204 return to step 806 e.g., waiting for the next steering position request from the VCU 700. In some examples, the alert can indicate that inspection, repair or maintenance is needed. In some examples, the alert generated in step 816 is optionally displayed to a user in the vehicle.

In step 814, the first or second ECUs 202, 204 can determine that the steering shaft 200 is offset during a straight-ahead position in various different ways.

In some examples, after the first or second ECUs 202, 204 has determined a vehicle steady state condition, the first or second ECUs 202, 204 determine whether a shaft centre signal has been received within a predetermined period of time. The predetermined period of time can be e.g., 0.1s, 1s, 5s, 10s etc. If the shaft centre signal has not been received by the first or second ECUs 202, 204 with the predetermined period of time, then the first or second ECUs 202, 204 determine that the midpoint 260 of the steering shaft 200 is offset from the geometric centre C of the steering assembly 100. Therefore, the first or second ECUs 202, 204 is configured to generate the alert in step 816 when time the steering shaft 200 is offset exceeds the predetermined period of time.

Furthermore, in some further examples, the first or second ECUs 202, 204 determines that the shaft centre signal is received at a determined frequency. In this case, the first or second ECUs 202, 204 uses information relating to the wheel rotation and determines that the offset of the steering shaft 200 depends on the wheel rotation. Therefore, the first or second ECUs 202, 204 is configured to generate the alert in step 816 when the steering shaft 200 is offset and the offset varies as a function of the wheel rotation.

When the vehicle is in a straight-ahead position, a fault condition comprising a wheel out of balance will cause minor changes in the elevation of the first or second tie-rod 104, 108 between the steering assembly 100 and the knuckle. These changes can be detected based upon a small oscillation in the position of the steering shaft 200, that will be proportional to the out-of-balance rotation of the wheel. By syncing the oscillation of steering shaft 200 with the rotational speed of the wheel, the first or second ECUs 202, 204 can determine that an oscillation that occurs once a revolution is of a first order nature and related to out-of-balance wheels or bearings. In addition, as vehicle speed (or wheel speed) increases so too will the out-of-balance force and the magnitude of oscillations into the steering shaft 200. Therefore, the first or second ECUs 202, 204 is able to detect a first order oscillation. If the oscillation increases and decreases with speed, the first or second ECUs 202, 204 can determine that the cause is due to an out-of-balance wheel, bearing; or worn bearing.

In some other examples, the after the first or second ECUs 202, 204 has determined a vehicle steady state condition, the first or second ECUs 202, 204 determines the magnitude of the displacement of the offset of the midpoint 260 of the steering shaft 200 from the geometric centre C of the steering assembly 100. In some examples, the first or second ECUs 202, 204 determine the displacement of the steering shaft 200 basis on other sensor information. For example, the first or second ECUs 202, 204 determine the displacement of the steering shaft 200 based on the rotational information of the first or second motor 208, 210 as mentioned above. Alternatively, other sensor signals can be used to determine the displacement of the steering shaft 200. The first or second ECUs 202, 204 then determine whether the displacement of the steering shaft 200 exceeds a predetermined deviation from the geometric centre C. For example, the screw actuator 228 in some examples is configured to adjust the steering shaft 200 within a tolerance of 0.05 mm. Therefore, the first or second ECUs 202, 204 is configured to generate the alert in step 816 when the determined displacement of the steering shaft 200 exceeds 0.05 mm. For example, the displacement of the steering shaft 200 is 5 mm when the first tire experiences a reduction in the side wall of approximately 70 mm. Since 5 mm exceeds the predetermined threshold of 0.05 mm, the first or second ECUs 202, 204 is configured to generate the alert in step 816.

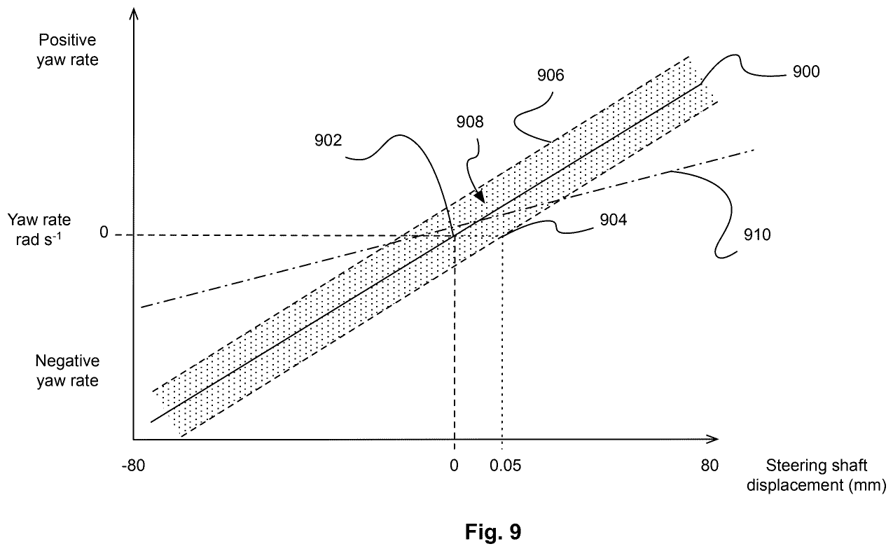

In some other examples, the first or second ECUs 202, 204 determine whether the yaw rate as a function of the displacement of the steering shaft 200 is within a predetermined range. FIG. 9 shows a graph of an example of yaw rate against steering shaft displacement. In normal operation, the yaw rate-displacement relationship is expected to follow a predetermined linear relationship 900. In other examples, the first or second ECUs 202, 204 determine that the yaw rate-displacement relationship follows a non-linear relationship e.g. the first or second ECUs 202, 204 determine that the relationship between the yaw rate and displacement is a sinusoidal function due to the geometry of the steering assembly 100. For example, when the yaw rate of the vehicle is 0 rad s⁻¹, or within a predefined yaw rate tolerance the expected steering shaft displacement from the geometric centre C is 0 mm at first intersection 902. In some examples, the predefined yaw rate tolerance is ±0.01 rad s⁻¹, ±0.05 rad s⁻¹, ±0.1 rad s⁻¹, ±0. 15 rad s⁻¹, ±0.2 rad s⁻¹, ±0.25 rad s⁻¹ etc or any other suitable predefined yaw rate tolerance.

The first or second ECUs 202, 204 determine are configured to determine whether the linear relationship between the yaw rate and the displacement is outside a predetermined linear relationship 900. For example, the permitted variation 906 outside the linear relationship can be ±0.05mm. The permitted variation 906 is represented in FIG. 9 as the dotted area 906 surrounding the predetermined linear relationship 900. At second intersection 904, the displacement of the steering shaft 200 is determined to be 0.05 mm when the yaw rate is 0 rad s⁻¹. The first or second ECUs 202, 204 accordingly determine this displacement of the steering shaft 200 is acceptable since this is within the permitted variation 906. However, the first or second ECUs 202, 204 will generate an alert if the current displacement of the steering shaft 200 exceeds the permitted variation 906. In some examples, the permitted variation 906 in the displacement can be any suitable displacement, depending on the components and tolerance thereof.

In some examples, the first or second ECUs 202, 204 can determine that the linear relationship between yaw rate and the displacement exhibits a different linear relationship 910 from the predetermined linear relationship 900. In this case, the first or second ECUs 202, 204 may generate the alert even if the determined displacement is within the permitted variation 906 of the predetermined linear relationship 900 as shown in the overlap region 908. This is because the variation between the relationship between yaw rate and the displacement indicates a fault condition.

Optionally, before the first or second ECUs 202, 204 generate the alert in step 816, the first or second ECUs 202, 204 determines the fault type in step 818.

As mentioned previously, when the first or second ECUs 202, 204 is offset during a straight-ahead position, the offset can be because of a flat tire of e.g., the first wheel 504. However, the offset during a straight-ahead position can also be due to an out-of specification geometry of the chassis. In order to distinguish between a flat tire fault and an out of specification geometry fault, the first or second ECUs 202, 204 is configured to receive a tire pressure signal from a tire pressure sensor 706 from the CAN BUS 702. If the first or second ECUs 202, 204 determine from the tire pressure signal that there is a low pressure in the first wheel 504, the first or second ECUs 202, 204 confirms that there is a flat tire fault in step 818. The generated alert in step 816 can comprise information relating to the type of fault condition of the vehicle.

In some examples, the tire pressure sensor 706 is a tire pressure monitoring system sensor (TPMS). This means that the tire pressure sensor 706 is mounted in the valve of the tire and directly detects the pressure of the wheel. In some other examples the tire pressure sensor 706 is an indirect tire pressure monitoring system (iTPMS) sensor. In this example the tire pressure sensor 706 indirectly detects the tire pressure of the wheel from differential wheel speed rotation. The first or second ECUs 202, 204 are configured to receive the tire pressure signal from the tire pressure sensor 706 whether it is a TPMS or an iTPMS via the CAN BUS 702 or via another data connection.

Alternatively, if the first or second ECUs 202, 204 determine from the tire pressure signal that there is a normal pressure in the first wheel 504, the first or second ECUs 202, 204 confirms that either there is an out of specification geometry or that there is a fault with the tire pressure sensor 706 in step 818. The generated alert in step 816 can comprise information relating to the type of fault condition of the vehicle.

When the first or second ECUs 202, 204 is offset during a straight-ahead position, the offset can vary as a function of the wheel rotation. The first or second ECUs 202, 204 receive the wheel rotational speed from the CAN BUS 702. In this case the first or second ECUs 202, 204 determines that the variation of the offset is a first order response with respect to the rotation of the first wheel 504. The first or second ECUs 202, 204 then determine that the first wheel 504 is out of balance in step 818. The generated alert in step 816 can comprise information relating to the type of fault condition of the vehicle.

In some other examples, the first or second ECUs 202, 204 can receive information from a ride or corner height sensor(s) (not shown). The ride height sensor(s) is typically mounted to the vehicle suspension and detects the height of a specific point of the vehicle above the road. The first or second ECUs 202, 204 are configured to receive the signal from the ride height sensor in step 818 as shown in FIG. 8. Here the first or second ECUs 202, 204 can better determine a fault and a fault type and increase the confidence in the determination when additionally using the signal received from the ride height sensor(s).

In another example, two or more examples are combined. Features of one example can be combined with features of other examples.

Examples of the present disclosure have been discussed with particular reference to the examples illustrated. However, it will be appreciated that variations and modifications may be made to the examples described within the scope of the disclosure.

1. A steer-by-wire steering assembly for a vehicle comprising:
a housing;
at least one electronic control unit;
motor assembly having at least one rotor and at least one stator and the at least one electronic control unit is configured to control the motor assembly;
an actuator operatively coupled to the at least one rotor;
a steering shaft connectable to a first tie rod and a second tie rod, the steering shaft configured to engage with the actuator and to move longitudinally with respect to the housing when the motor assembly is actuated;
a steering shaft displacement sensor configured to send a signal to the at least one electronic control unit in dependence of detecting a centre reference target of the steering shaft;
wherein the electronic control unit is configured to determine a vehicle steady state condition and determine in dependence of the signal from the steering shaft displacement sensor a steering shaft offset when the vehicle is in the vehicle steady state condition.

2. The steer-by-wire steering assembly according to claim 1 wherein the centre reference target indicates a midpoint of the steering shaft and when the centre reference target is detected by the steering shaft displacement sensor, the midpoint of the steering shaft is aligned with a geometric centre of the steering assembly.

3. The steer-by-wire steering assembly according to claim 1 wherein the at least one electronic control unit is configured to determine a displacement of the steering shaft in dependence of the signal from the steering shaft displacement sensor and rotational information of the at least one rotor.

4. The steer-by-wire steering assembly according to claim 1 wherein the at least one electronic control unit is configured to receive an indication of a vehicle steady state or information for determining a vehicle steady state condition.

5. The steer-by-wire steering assembly according to claim 4 wherein the at least one electronic control unit is configured to receive the indication of a vehicle steady state or information for determining a vehicle steady state condition from a vehicle control unit, a vehicle movement controller, a controller area network of the vehicle, a yaw rate sensor, at least one wheel speed sensor, or at least one ride height sensor.

6. The steer-by-wire steering assembly according to claim 4 wherein the indication of the vehicle steady state comprises a yaw rate of the vehicle, and/or wheel speed.

7. (canceled)

8. The steer-by-wire steering assembly according to claim 1 wherein the at least one electronic control unit is configured to determine a steering fault condition based the determination that steering shaft is offset when the vehicle is in a vehicle steady state.

9. The steer-by-wire steering assembly according to claim 8 wherein the at least one electronic control unit is configured to determine the steering fault condition when the steering shaft offset of the steering shaft exceeds a predetermined displacement.

10. (canceled)

11. The steer-by-wire steering assembly according to claim 8 wherein the at least one electronic control unit is configured to determine the steering fault condition when a relationship between the steering shaft offset and a yaw rate of the vehicle exceeds a predetermined permitted variation.

12. The steer-by-wire steering assembly according to claim 1 wherein the at least one electronic control unit is configured to determine that the steering shaft offset varies in dependence of a wheel rotation and/or with wheel speed.

13. The steer-by-wire steering assembly according to claim 8 wherein the at least one electronic control unit is configured to determine whether the steering fault condition is one or more of a tire pressure fault, chassis geometry fault, or out of balance wheel, or wheel bearing fault.

14. The steer-by-wire steering assembly according to claim 1 wherein the at least one electronic control unit is configured to receive a signal from a tire pressure sensor or a tire pressure loss sensor.

15. The steer-by-wire steering assembly according to claim 12 wherein the at least one electronic control unit is configured to determine a flat tire condition based on the signal received from a tire pressure sensor and a steering fault condition.

16. The steer-by-wire steering assembly according to claim 1 wherein the actuator is a screw actuator configured to engage a threaded portion on the steering shaft.

17. The steer-by-wire steering assembly according to claim 1 wherein the motor assembly comprises a first motor having a first stator comprising a first motor winding and a second motor having a second stator comprising a second motor winding wherein the at least one rotor is common to both the first motor and the second motor.

18. The steer-by-wire steering assembly according to claim 1 wherein the at least one electronic control unit is a first electronic control unit configured to control a first motor winding and a second electronic control unit configured to control the second motor winding.

19. (canceled)

20. A method of controlling a steer-by-wire steering assembly for a vehicle having a housing; at least one electronic control unit; a motor assembly having at least one rotor and at least one stator and the at least one electronic control unit is configured to control the motor assembly, an actuator operatively coupled to the at least one rotor and a steering shaft connectable to a first tie rod and a second tie rod, the steering shaft configured to engage with the actuator and to move longitudinally with respect to the housing when the motor assembly is actuated, the method comprising:
detecting a centre reference target of the steering shaft with a steering shaft displacement sensor;
sending a signal from the steering shaft displacement sensor to the at least one electronic control unit;
determining a vehicle steady state condition;
determining in dependence of the signal from the steering shaft displacement sensor that a displacement of the steering shaft is offset when the vehicle is in a vehicle steady state.

21. A steer-by-wire steering assembly for a vehicle comprising:
a housing;
at least one electronic control unit;
a motor assembly having at least one rotor and at least one stator and the at least one electronic control unit is configured to control the motor assembly;
an actuator operatively coupled to the at least one rotor;
a steering shaft connectable to a first tie rod and a second tie rod, the steering shaft configured to engage with the actuator and to move longitudinally with respect to the housing when the motor assembly is actuated;
a steering shaft displacement sensor and configured to send a signal to the at least one electronic control unit in dependence of detecting a centre reference target of the steering shaft;
wherein the electronic control unit is configured to determine a rotation of a wheel and in dependence of the signal from the steering shaft displacement sensor determine that a displacement of the steering shaft is offset in dependence of the rotation of the wheel.

22. The steer-by-wire steering assembly according to claim 18 wherein the at least one electronic control unit is configured to determine rotation of a wheel from one or more of a wheel rotation sensor or an indication of wheel rotation.

23.-24. (canceled)

25. A steer-by-wire steering assembly for a vehicle comprising:
a housing;
at least one electronic control unit;
a motor assembly having at least one rotor and at least one stator and the at least one electronic control unit is configured to control the motor assembly;
an actuator operatively coupled to the at least one rotor;
a steering shaft connectable to a first tie rod and a second tie rod, the steering shaft configured to engage with the actuator and to move longitudinally with respect to the housing when a first motor winding and/or a second motor winding is actuated;
a steering shaft displacement sensor and configured to send a signal to the at least one electronic control unit in dependence of detecting a centre reference target of the steering shaft;
at least one tire pressure sensor or tire pressure loss sensor configured to generate a pressure signal of a wheel mounted to the first tie rod or the second tie rod;
wherein the electronic control unit is configured to determine a vehicle steady state condition, determine a steering shaft offset from the signal from the steering shaft displacement sensor, and determine a fault condition of the at least one tire pressure sensor on the basis of the determined vehicle steady state condition and the determined steering shaft offset.
